(19) United States
(12) Patent Application Publication
(10) Pub. No.: US 2020/0125520 A1
(43) Pub. Date: Apr. 23, 2020

(54) Methods and Systems for Assigning Addresses to Devices That Use Master / Slave Communication Protocols

(71) Applicant: Astronics Advanced Electronic Systems Corp., Kirkland, WA (US)

(72) Inventor: David Perchlik, Redmond, WA (US)

(21) Appl. No.: 16/591,343

(22) Filed: Oct. 2, 2019

Related U.S. Application Data
(60) Provisional application No. 62/749,161, filed on Oct. 23, 2018.

(51) Int. Cl. G06F 13/40; G06F 1/26

(52) U.S. Cl. CPC G06F 13/4027; G06F 1/266; G06F 13/4022

(57) ABSTRACT

Systems and methods are provided for assigning unique addresses to multiple slave devices on a network implemented in a star configuration, having individual power and/or data buses connecting the slave devices to a master device. A switching circuit on the master side of the system is used to allow a unique address to be assigned to one slave node at a time. A control circuit determines the state of the switching circuit and directs the master device to re-address each slave node at the appropriate time, so as to assign a unique address.

### CROSS-REFERENCE TO RELATED APPLICATIONS

The present application claims priority to U.S. Provisional Patent Application No. 62/749,161 that was filed Oct. 23, 2018, the contents of which is hereby incorporated by reference in its entirety.

### FIELD OF THE DISCLOSURE

The present disclosure is directed to systems and methods for assigning unique communication addresses to each of a plurality of devices on a network, for example in a network that may provide power to each of the plural devices through individual power lines routed to each device. In such an exemplary network, each power line may be controlled by logic for enabling power to be supplied to each device on the network. The present disclosure is of particular utility in aircraft installations where a goal is to minimize cabling weight and wiring between devices on the network.

### BACKGROUND

A typical network connection diagram 10 is shown in FIG. 1, for the case where the network operates under the local interconnect network (LIN) protocol. This exemplary LIN network protocol has been developed as a relatively low-cost network protocol for automotive and other applications.

In such LIN network, a plurality of slave devices (or nodes) 12 are connected to a master device or node 16 by a common LIN bus 14. For proper communications with the master device 16, each of the slave devices must have a unique address assigned to it. In FIG. 1 the addresses are represented by A, B, C, D.

Existing auto-addressing methods for such networks require serial connection between slave nodes (e.g., in a ring network arrangement) or additional wire or additional circuits. For example, prior art methods for assigning unique addresses to each one of a plurality of slave devices are disclosed in U.S. Pat. No. 7,694,050, “Method and System for Addressing Multiple Instances of a Same Type Device on a Bus” by Chan et al. and U.S. Pat. No. 9,678,908, “Method for Automatically Setting ID in UART Ring Communication” by Lee. Typically, the prior art slave devices initially have the same configuration including the same starting default address. Both U.S. Pat. Nos. 7,694,050 and 9,678,908 are incorporated by reference herein in their entireties.

However, the above prior art approaches do not effectively meet the requirements and limitations associated with installation of such networks, including in particular, power distribution networks, in an aircraft cabin. Moreover, implementations that require pre-addressing of each slave device are cumbersome and complicate installation. Therefore, there is a need for systems and methods that can assign unique addresses to slave devices on a network, as may required by the network.

The present disclosure mitigates the short comings of the prior art by providing systems and methods for assigning addresses to slave devices arranged on a network, that is slaves 12A-12D interconnected by a common communication bus 14 that facilitates data transmission both between individual slave devices and between those individual slave devices and a master device 16. This method is illustrated in the context of a LIN network, in which multiple slave devices are connected in a star configuration to a common master device, as shown in FIG. 2. Such a star network configuration is ideally suited for an aircraft cabin where it is desirable to keep cabling lengths to a minimum.

FIG. 2 shows a wiring configuration in which an In Seat Power Supply (ISPS) 18 that is designed to supply power to multiple outlets, (e.g., USB outlet ports for charging devices at your seat within an aircraft cabin) is connected to four such power outlets 20. To minimize cabling, a set of wires 22 runs from the ISPS 18 to each power outlet 20. In the exemplary embodiment of FIG. 2, wires 22 also include a LIN communication bus between a LIN master device in the ISPS 18 and a LIN slave device in each power outlet 20. To individually monitor and control the outlets 20 through such exemplary network arrangement, each power outlet 20 needs to be assigned its own unique address.

### SUMMARY

As noted above, in such exemplary power distribution arrangement, a LIN bus may be included that interfaces the ISPS 18 with the outlets 20, so that the ISPS 18 is able to monitor and individually control each of the power outlets 20. In the FIG. 2 arrangement, a master LIN device is provided at the ISPS. However, it is understood that other bus configurations may also be used and all fall within the spirit of this disclosure.

In the exemplary FIG. 2 embodiment, each of the power outlets 20 is configured as a slave device on the LIN network and is connected to the master device in a star topology via a LIN network bus. In order for the master device to properly communicate with any particular slave device, each of the slave devices must have a unique address. The disclosed systems and methods use switching controlled by the master device side of the network to initially isolate each slave device so that it can be programmed with a unique address that it will use thereafter. One advantage of this method over prior art methods is that it allows for common and simple slave devices to be used.

Thus, this disclosure describes exemplary systems and methods for isolating each slave device on the network so that it can be assigned a unique address. In a first method described below, the master side of the network places all but one LIN bus connection in an open state. This permits the single connected slave device to be programmed with a unique address. In a second method described further below, power is removed from all except one slave device. Since only that one powered slave device is able to respond to network commands, it is possible to assign a unique address to that slave device. This process may be repeated to assign addresses to other slave devices, to the extent needed.

It should be noted that the terms “master node,” “master device,” and “master” are used interchangeably herein. Similarly, the terms “slave node,” “slave device,” and “slave” are also used interchangeably herein. These terms have conventional meanings as would be understood by persons of ordinary skill in the art. Additionally, the term “re-address” is used herein in the context of assigning a unique address to a device that may initially have a default address.

### BRIEF DESCRIPTION OF THE DRAWINGS

FIG. 1 illustrates a network connection diagram as known in the prior art in which an exemplary LIN bus interfaces a master node to a plurality of slave nodes.

FIG. 2 illustrates an exemplary LIN bus configuration wherein the connections between the master and slaves form a star configuration.

FIG. 3 is a diagram of an exemplary embodiment in which the LIN communication bus connected to each slave is individually switched so as to assign a unique address to each slave.

FIG. 4 is a diagram of an exemplary embodiment in which the power bus connected to each slave is individually switched so as to assign a unique address to each slave.

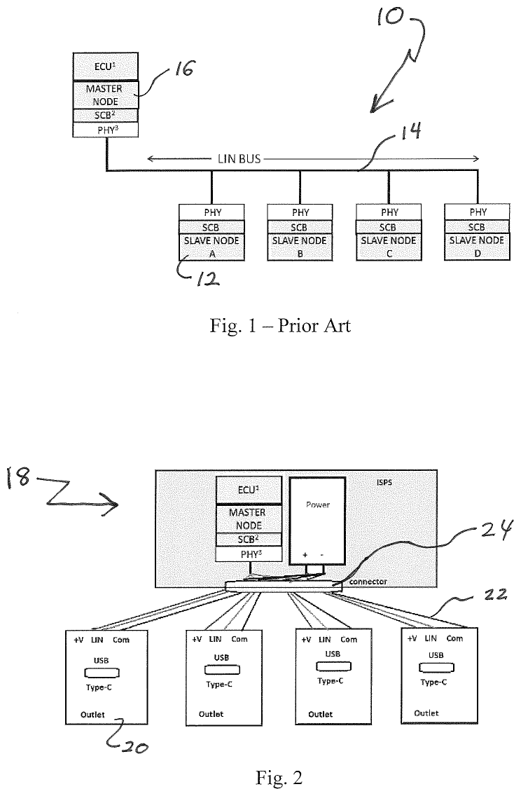

### DETAILED DESCRIPTION

The disclosed systems and methods provide various ways of assigning unique addresses to one or more multiple slave devices connected in a star configuration to a common master device via a communication bus. While the multiple slave devices in the specific embodiments described herein are power outlets connected in a network, the slave devices may include any type of electrically or optically connectable devices that need to be arranged on and controlled by a network. Such slave devices may include various sensors, controllers, lighting devices, motors, human-machine interfaces, etc., to name but a few types of devices.

As an exemplary embodiment of the present invention, FIG. 2 shows a wiring configuration for connecting ISPS 18 to power outlets 20. Four power outlets, of the type typically found in an aircraft passenger cabin, are illustrated. However that is only an exemplary number. To minimize cabling, a set of wires 22 is run from the ISPS 18 to each power outlet 20. Each outlet 20 on the network needs to be initialized to have its own unique address. To assign such unique address, at power-up, each slave node on the network (i.e. at each outlet 20) may be isolated by the master node (at the ISPS 18), either by switching the LIN bus going to that particular slave node; or by switching the power going to that particular slave node. This approach allows the master node to successively connect to and assign a unique address to each slave node, one at a time.

Although the embodiments disclosed herein describe systems and methods of assigning unique slave addresses at power-up, i.e., when power is first applied to the master device and slave devices, the present invention is not limited to such an implementation. For example, a slave device may be provided with a nonvolatile memory that retains a previously assigned unique address and thus may not require reassignment of an address at power-up when it is added to the network. As another example, without powering down an already powered system, hot-swappable slave devices may be newly connected via the network to the master device. In such event, the master device may be configured to periodically poll the status of connected slave devices and, by using the systems and methods disclosed here, assign unique addresses to only those newly connected slave devices that have not yet been assigned a unique address.

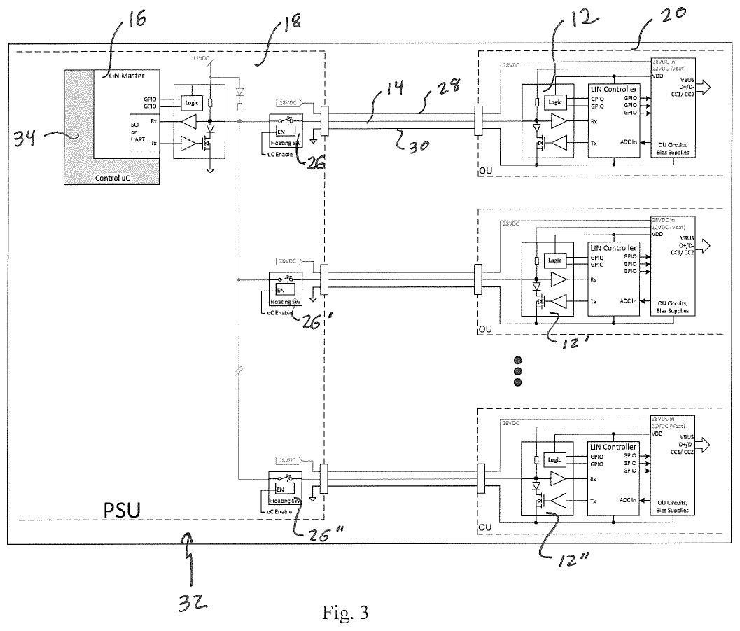

Referring specifically to FIG. 3, each power outlet 20 includes a LIN slave node 12 having a LIN controller. As shown, each power outlet 20 is connected to the ISPS 18 via a LIN bus line 14, a power line 28 (typically providing 28 volts DC in an aircraft environment), and a ground line 30. The Power Supply Unit (PSU) 32 illustrated in FIG. 3, and described herein, includes at least the ISPS 18. As shown, ISPS 18 includes a microcontroller 34 and a LIN master node 16.

With further reference to FIG. 3, a first embodiment is described that includes a switch 26 and corresponding switch control for controllably switching each of the LIN bus line connections 14 to the power outlets 20.

While specific reference is made herein to a LIN bus and connectors, it should be appreciated than many other bus protocols may also be employed in accordance with this disclosure and embodiment, so long as they are able to perform re-addressing of the slave nodes.

In particular, FIG. 3 depicts an implementation where the LIN master device 16 includes a microcontroller 34 that may individually control switches 26 that are in series with the LIN bus line 14 connected to each slave device 12. The microcontroller 34 has programming that successively closes one switch 26 at a time during a power-up sequence, thereby connecting only one LIN bus line 14 at a time to its corresponding slave node 12. After each switch 26 activation, the master device 16 sends an address assignment command to the attached slave node 12 to assign a unique address to that slave node.

In other embodiments, the switches 26 and their corresponding switch controls may be provided externally to the power supply 18. Such an implementation may be necessary, for example, when the present invention is applied to a power supply 32 that is not internally equipped with individual switches 26. In certain other embodiments, the microcontroller 34 may also be programmed to perform other functions required by the ISPS 18.

With further reference to FIG. 3, the slave nodes 12 are part of power outlets 20. These LIN-capable power outlets 20 enable features that would not be possible without network communication between the ISPS 18 and the power outlet 20. The various features and capabilities made possible by the subject matter of the present disclosure are summarized below:

Connection Control—Connection control is accomplished by the microcontroller 34 having control of switches 26 so that they can be opened or closed by the microcontroller 34. The microcontroller 34 has programing that determines when the switches 26 should be opened or closed. In this FIG. 3 implementation the switches 26 are in series with each LIN bus line 14 that is connected to the slave node 12 located in a power outlet 20.

Addressing—Each outlet 20 may be built with slave nodes 12 that have the same initial default address. This allows the outlets 20 to be interchangeable and field replaceable with no need for individual address programing. As described above, when the system is enabled, power may be applied to all outlets 20 but the LIN bus switches 26 may all be in an open state. During an initialization phase the microcontroller 34 will close one LIN bus switch 26 at a time. With one LIN bus switch 26 closed, the master 16 is connected to only one slave 12 and the master will send a command to re-address the connected slave from its initial default address to a unique address defined by the master. The microcontroller 34 may then open the LIN bus switch 26 of the first slave 12 and close the switch 26′ for the next slave 12′. In this manner, each individually connected slave 12, 12′, 12″ can be re-addressed with a unique address.

Normal Operation—After re-addressing all outlets 20, the system enters normal operation where all switches 26, 26′, 26″ are closed and the master 16 can communicate with any or all of the slaves 12, 12′, 12″ since they now have unique addresses.

Failure Mode—If a failure is detected in any outlet 20, the microcontroller 34 has the ability to disconnect the LIN bus 14 from the outlet 20 with the failure. This is advantageous in a situation where the outlet 20 may experience a failure that would interrupt the communication bus 14.

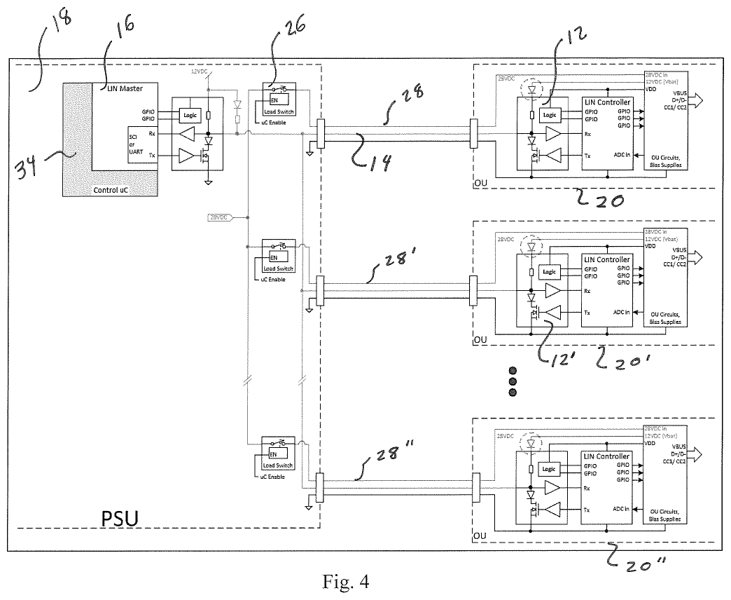

FIG. 4 illustrates a second embodiment of the present invention and depicts an implementation wherein the LIN master device 16 has control of switches 26 that are in series with the power bus lines 28 that supply power to each power outlet 20. In this exemplary embodiment, the LIN master 16 is located in ISPS 18, which also includes microcontroller 34. The microcontroller 34 has programming that turns on one switch 26 at a time during the power-up sequence to power up a corresponding slave device. With each switch 26 activation, the master 16 sends an address assignment command via the LIN bus 14 which is received by the attached slave 12 that is powered up.

With reference to FIG. 4, this implementation may offer an added advantage when power bus switching by way of power bus switches 26 is already included in the ISPS 18. A typical ISPS 18 is generally equipped with on/off control of each power bus 28, since such on/off control is needed to disable power to any slave device (e.g., power outlet) with a detected fault condition. With on/off power control already in the ISPS 18, this implementation requires no additional switching hardware to perform the re-addressing of the slave devices 12.

In other embodiments, the power bus switches 26 may be provided externally to the power supply unit (PSU) 32. Such an implementation would be necessary, for example, when the present invention is applied to an ISPS 18 not already equipped with internal power bus switches 26. The following features are provided by this embodiment:

Connection Control—In the FIG. 4 embodiment, connection control is accomplished by the microcontroller 34 and switches 26 that can be opened or closed by the microcontroller 34 to disable power to the corresponding slave device. The microcontroller 34 has programming that determines when the switches 26 should be opened or closed. In this implementation the switches 26 are in series with each power bus line 28 that is connected to the slave node 12 located in a power outlet 20.

Addressing—Each outlet 20 is built with slave nodes 12 that have the same default address. This allows the outlets 20 to be interchangeable and field replicable with no need for individual address programing. When the system is enabled, power will be sequentially applied to each of the power lines 28, 28′, 28″ so that only one slave device (power outlet 20) is powered. Since power is provided to only one outlet 20 at a time, only that outlet 20 can respond to LIN commands received via LIN bus 14. During power-up initialization, the master 16 will send a command to re-address the slave node 12 in the powered outlet 20, so as to change its initial default address to a unique address. The microcontroller 34 will then enable power to the second outlet 20′ that has a default address. The second slave node 12′ will be re-addressed with a unique address. Each additional outlet 20″ will have power applied one at a time and will be assigned a unique address.

Normal Operation—After re-addressing all outlets 20, 20′, 20″, the system enters normal operation and the master 16 can communicate with any or all of the slaves 12, 12′, 12″ that now have unique addressing.

Failure Mode—If a failure is detected in any outlet 20, 20′ 20″, the microcontroller 34 has the ability to disconnect power of the outlet with the failure.

Although the present invention has been described with reference to particular embodiments, this description is not meant to be construed in a limiting sense. Various modifications of the disclosed embodiments as well as alternative embodiments of the invention will become apparent to persons of ordinary skill in the art. It is therefore contemplated that the appended claims will cover any such modifications or embodiments that fall within the scope of the invention.

What is claimed is:

1. A method for assigning a unique address to one or more of a plurality of slave devices connected in a star configuration to a master device, comprising the steps of:
connecting each of the one or more slave devices one at a time to the master device; and
configuring the master device to assign a unique address to the connected slave device.

2. The method of claim 1, wherein the step of connecting further comprises switchably connecting a communication bus between the master device and the slave device being connected.

3. The method of claim 2, further comprising the step of transmitting the unique address to the connected slave device on the communication bus.

4. The method of claim 2, wherein the communication bus is a LIN bus.

5. The method of claim 2, wherein the step of connecting further comprises powering up the one or more slave devices one at a time.

6. The method of claim 5, wherein the step of powering up further comprises switchably connecting a power bus between the master device and the one or more slave devices.

7. The method of claim 3, further comprising the steps of:
polling, by the master device, of the address status of each of the one or more slave devices; and
assigning a unique address only to the one or more slave devices requiring address assignment.

8. A system for assigning a unique address to one or more of a plurality of slave devices, the slave devices connected in a star configuration to a master device via a communication bus, the system comprising:
a switch disposed on the communication bus between the master device and each slave device; and
a controller configured to close the switch to connect only one of the slave devices at a time;
wherein the master device transmits an address assignment command to the connected one of the slave devices.

9. The system of claim 8, wherein the slave devices are incorporated in power outlets in an aircraft.

10. The system of claim 8, wherein the controller is in the master device.

11. The system of claim 8, wherein the communication bus is a LIN bus.

12. A system for assigning a unique address to one or more of a plurality of slave devices, the slave devices connected in a star configuration to a master device via a communication bus, the system comprising:
a power bus for supplying power to the plurality of slave devices;
switches for connecting the power bus to each of the plurality of slave devices; and
a controller configured to switchably connect the power bus to power only one of said slave devices at a time;
wherein the master device transmits an address assignment command to said one slave device when so powered.

13. The system of claim 12, wherein the communication bus is a LIN bus.

14. The system of claim 12, wherein the slave devices are incorporated in an in-seat power outlet used in an aircraft.

15. The system of claim 12, wherein the master device is incorporated in an aircraft power supply.

16. The system of claim 12, wherein the aircraft power supply supplies power to a plurality of in-seat power outlets.

17. The system of claim 12, wherein the power bus switches are incorporated in the power supply.

18. The system of claim 12, wherein the power bus switches are provided external to the power supply.

19. The system of claim 8, wherein the switch is incorporated in the power supply.

20. The system of claim 8, wherein the switch is external to the power supply.
